(19) United States
(12) Patent Application Publication
(10) Pub. No.: US 2005/0252536 A1
(43) Pub. Date: Nov. 17, 2005

(54) Wiper blade wash station, spray bar and process for cleaning the wiper blade

(76) Inventors: Michael N. Ciliberti, East Fallowfield, PA (US); Charles W. Dodson JR., Morgantown, PA (US); Richard Hochheim, Chadds Ford, PA (US); Leonardo R. Rota, Havertown, PA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/117,595

(22) Filed: Apr. 28, 2005

Related U.S. Application Data
(60) Provisional application No. 60/571,050, filed on May 14, 2004.

(51) Int. Cl. B08B 3/00; B08B 3/12; B08B 6/00

(52) U.S. Cl. 134/34; 134/184

(57) ABSTRACT

The present invention relates to various embodiments for a wash station for use with ink jet printers, wherein the risk of experiencing print performance problems due to contaminated wiper blades is reduced. The wash station provides for the storage of the wiper blade in a washing fluid for the removal of contaminants.

### CROSS-REFERENCE TO RELATED APPLICATIONS

This application claims priority under 35 U.S.C. §119 from U.S. Provisional Application Ser. No. 60/571,050 (filed May 14, 2004), the disclosure of which is incorporated by reference herein for all purposes as if fully set forth.

### BACKGROUND OF THE INVENTION

Generally in the ink jet printing industry, printing quality is determined by a number of factors, including establishment of a proper meniscus at the print head nozzle exit and providing clean print heads. In order to accomplish this, ink jet printers typically use some type of wiper blade. However, over time the wiper blade collects ink, media lint and/or other debris that becomes difficult to remove and can result in these contaminants impeding the performance of the wiper blade. As a result the wiper blade must be replaced more frequently, any remaining contaminants may contact the print head nozzle(s) and ultimately hindering print performance.

Thus, there is a need within the printing industry for an apparatus to properly maintain the wiper blade, wherein contaminants are removed on a regular basis, thereby allowing the wiper blade to properly wipe the print head(s) and preventing print performance problems.

### SUMMARY OF THE INVENTION

In one embodiment of the present invention, there is provided a wash station (1) comprising:
(a) a wiper blade assembly (2) comprising a wiper blade (3) and a support bar (4);
(b) an immersion tank (5) comprising a spray bar (6) having at least one aperture (10) and a washing fluid (7), wherein the wiper blade (3) is immersed therein; and
(c) a drive mechanism (8) for moving the wiper blade (3) into the immersion tank (5).

Another embodiment of the present invention relates to a process for cleaning a wiper blade (in a wash station) comprising the steps of:
(1) immersing the wiper blade in a washing fluid when the wiper blade is not in use;
(2) subjecting the wiper blade to a washing fluid, wherein the fluid may optionally be agitated prior to contacting the wiper blade.

Yet another aspect of the present invention relates to spray bar (6) and an immersion tank (5) containing the spray bar (6) and optionally a washing fluid (7), wherein the spray bar (6) comprises a conduit pipe for carrying a stream of the washing fluid and at least one aperture (10) in the conduit pipe, wherein the aperture (10) directs the washing fluid stream at an angle of about 20 degrees in relation to a horizontal axis such that the washing fluid is agitated.

These and other features and advantages of the present invention will be more readily understood by those of ordinary skill in the art from a reading of the following detailed description. It is to be appreciated that certain features of the invention which are, for clarity, described above and below in the context of separate embodiments, may also be provided in combination in a single embodiment. Conversely, various features of the invention that are, for brevity, described in the context of a single embodiment, may also be provided separately or in any subcombination. In addition, references in the singular may also include the plural (for example, “a” and “an” may refer to one, or one or more) unless the context specifically states otherwise. Further, reference to values stated in ranges include each and every value within that range.

### BRIEF DESCRIPTION OF THE DRAWINGS

FIG. 1 shows a side view of an embodiment of an immersion tank.

FIG. 2 shows a cut-away view of an embodiment of an immersion tank and a spray bar.

FIG. 3 shows an embodiment of a wiper blade.

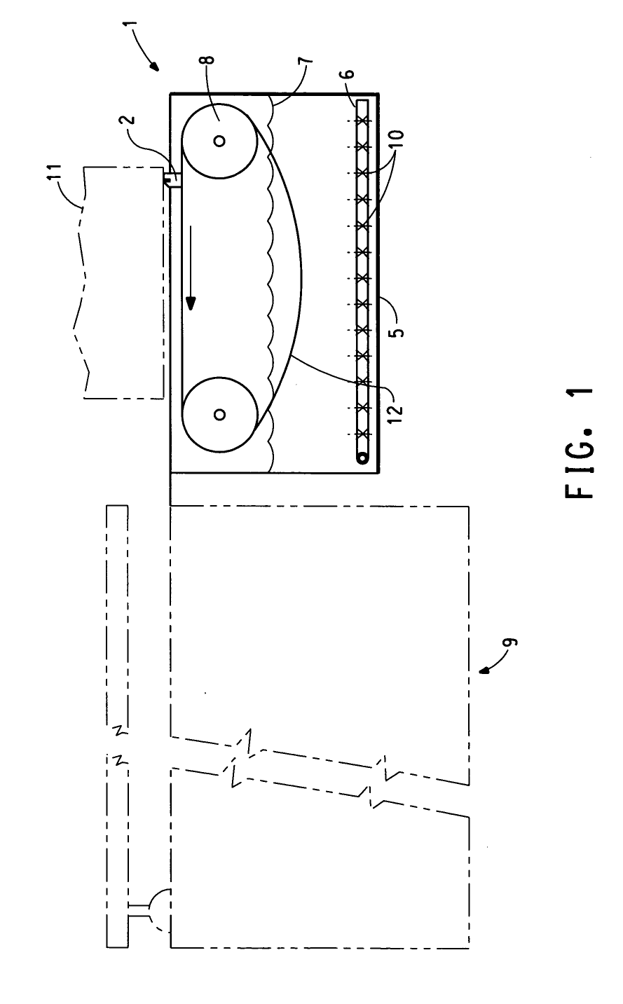

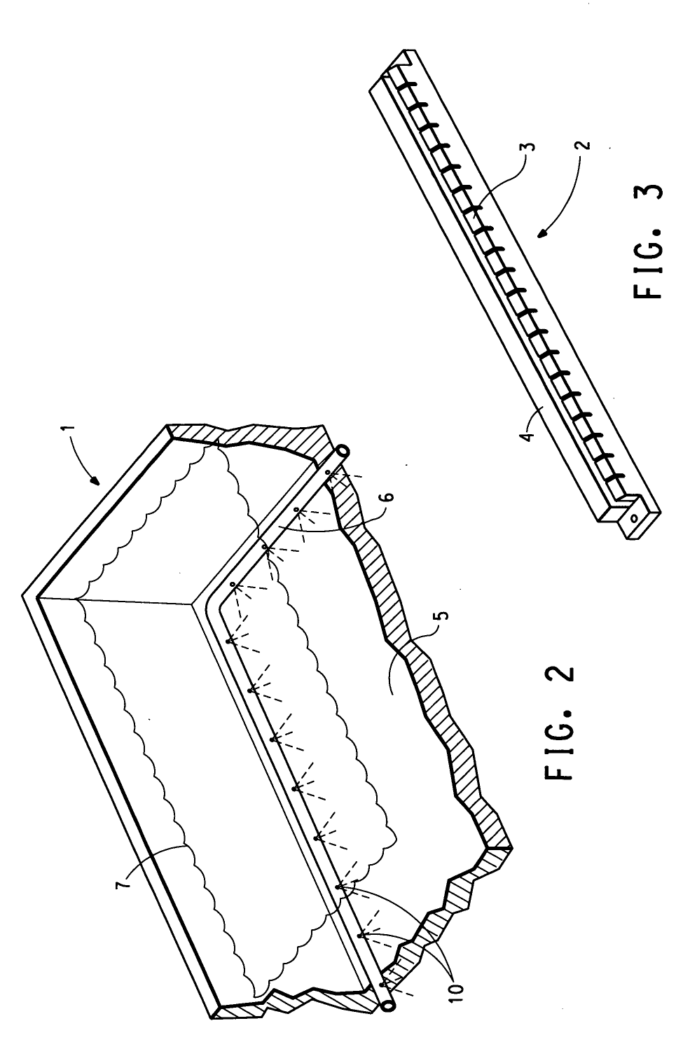

### DETAILED DESCRIPTION OF THE PREFERRED EMBODIMENTS

The embodiments of the present invention may be used as a wash station for use with ink jet printers or as processes including the same, wherein the risk of experiencing print performance problems due to contaminated wiper blades is reduced or prevented.

As noted above, one embodiment of the present invention relates to a wash station (1), which incorporates a wiper blade assembly (2) used to clean ink jet print head(s) (11). The wiper blade assembly (2) comprises a wiper blade (3) and a support (4), with the wiper blade (3) acting to remove contaminants such as ink residue, media lint (e.g. from frayed edges of various media types such as fabrics) and/or other debris from the print head(s) (11). Without proper cleaning of the wiper blade (3), any contaminants that were previously removed from the print head(s) (11) may be re-introduced back onto the print head(s) (11). The embodiments of the present invention are advantageous as a result of reducing the risk of experiencing printing performance problems due to inadequate wiping; and improving process efficiency and cost effectiveness due to less frequent wiper blade (3) replacement.

The wiper blade (3) for use in the embodiments of the present invention is in general known to those of ordinary skill in the relevant art. Preferably, the wiper blade (3) comprises an elastomeric material (e.g. soft flexible rubber, either natural or synthetic) that, preferably, does not absorb the contaminant ink or washing fluid. The wiper blade (3) may have a variety of dimensions, which depend upon the printer and printhead with which it is used, as is understood by skilled artisans.

As is known within the art, the wiper blade support bar (4) is generally used to stabilize the wiper blade (3) and provide rigidity for its structure. Typically, the support bar (4) is a rigid material capable of withstanding the pressures and forces exerted upon it during operation. Suitable materials are typically plastics (e.g. PVC) and metals (e.g. stainless steel), wherein these materials should not react with the washing fluid contained in the immersion tank (5). Preferably the support bar (4) is constructed of stainless steel.

The wiper blade (3) is typically immersed in a tank (5) comprising a spray bar (6) and containing a washing fluid (7) so that any contaminants may be removed from the surface of the wiper blade (3). Generally, the tank (5) is of such dimensions (width, length and depth) that allow it to accommodate the entirety of the wiper blade (3), if desired, to ensure proper rinsing of the blade as well as the washing fluid (7) and spray bar (6). Skilled artisans would recognize the necessary dimensions for the immersion tank (5) in order to all for its use in conjunction with a printer (9). Typically the immersion tank (5) is mounted on the printer (9) in a position below the catch tank (not pictured), if present.

The immersion tank (5) for use in the embodiments of the present invention should be constructed of suitable materials not subject to rusting or other corrosion and should not react with any of the washing fluid(s) that may be utilized. Examples of suitable materials include plastic (e.g. PVC (polyvinyl chloride)) or stainless steel, wherein stainless steel is preferred.

The spray bar (6) utilized in the embodiments of the present invention serves as a conduit to allow the washing fluid (7) to be introduced into the immersion tank to and contact the wiper blade (3). The spray bar (6) may be constructed of any material capable of retaining its form when subjected to the pressures and forces associated with its normal use. Examples of suitable materials include metals (e.g. stainless steel) and plastics (e.g. PVC (polyvinyl chloride)), however stainless steel is preferred. The washing fluid (7) travels through the interior of the spray bar (6) and is released into the immersion tank (5), preferably through at least one aperture (10), more preferably a plurality of apertures (10) along the entirety of its length so that the entire wiper blade (3) is subjected to the agitated washing fluid (7). As the washing fluid (7) passes through the aperture(s) (10), it becomes agitated, thereby assisting in removing contaminants from the wiper blade (3). The embodiments of the present invention provide for the replenishment of fresh fluid into the immersion tank (5) where the spray bar (6) is in fluid communication via a fluid line (not depicted) (e.g. rubber tubing) with a washing fluid source (not depicted).

The spray bar (6) preferably has an “L” shape, thereby allowing for agitation of the washing fluid (7) both in front of and behind the wiper blade (3). As noted above, the agitation of the washing fluid (7) is a result of the apertures (10) in the spray bar (6), wherein the aperture(s) (10) preferably have a round configuration. Generally, in cross-section the spray bar (6) has an axis that is parallel to the bottom of the immersion tank (5) (the “horizontal axis”) and an axis that is perpendicular to the bottom of the immersion tank (5) (the “vertical axis”. While general agitation of the washing fluid (7) results from its passage through the aperture(s) (10), preferably the apertures (10) are positioned such that the washing fluid is directed at about a 20-degree angle from the center of the fluid stream in relation to the horizontal axis.

Optionally, the spray bar (6) may have dual functionality, wherein the apertures (10) allow for the agitation of the washing fluid (7) in the area of the wiper blade (3), but also provide for the agitation of washing fluid (7) in the direct vicinity of the bottom of the immersion tank (5), thereby preventing sedimentation.

The washing fluid (7) should be delivered into the spray bar (6) under pressure in order to ensure proper agitation. Preferably, the pressure ranges from about 30 to about 70 psi, more preferably about 50 to about 60 psi.

The washing fluid (7) for use in the various embodiments of the present invention is used to remove any ink, lint and/or other contaminant from the wiper blade (3) to prevent its re-introduction to the print head(s). Preferably, the washing fluid (7) is agitated to further assist in removing contaminants from the wiper blade's surface. The washing fluid (7) may comprise a single fluid (e.g. water) or alternatively, may be a combination of fluids (e.g. water and one or more solvents and/or soaps, one or more solvents, one or more soaps or any combination thereof). Preferably, the washing fluid (7) is water. The washing fluid (7) may be introduced into the immersion tank (5) continuously, on a cyclic time schedule or on an “as needed” basis. Preferably, fresh washing fluid is provided after each rinsing of the wiper blade (3) to prevent any re-contamination.

The drive mechanism (8) for moving the wiper blade (3) through the washing fluid (7) may be any drive mechanism known to those skilled in the art. Suitable drive mechanisms (8) generally comprise a motor (e.g. direct drive or electrical motors (e.g. a DC Servo Motor Type TS 3252 E6, 60 Watts, 25 Volts; available from Tamagawa Seiko Co., Nagano Japan) (not depicted) connected to a chain, cable, belt or other equivalent (12), which is, in turn, engaged with the wiper blade assembly (2) to enable the wiper blade (3) to move through the washing fluid (7).

With respect to immersion of the wiper blade (3) in the washing fluid (7), preferably the wiper blade (3) remains in the washing fluid when not in use; however it may also be immersed intermittently at regular time intervals. Optionally, when not is use, the wiper blade (3) may be stored immersed in the washing fluid (7).

1. A wash station comprising:
(a) a wiper blade assembly comprising a wiper blade and a support bar;
(b) an immersion tank comprising a spray bar having at least one aperture and a washing fluid, wherein the wiper blade is immersed therein; and
(c) a drive mechanism for moving the wiper blade into the immersion tank.

2. The wash station according to claim 1, wherein the wiper blade is constructed of a flexible material.

3. The wash station according to claim 1, wherein the support bar comprises a rigid material selected from plastics and metals.

4. The wash station according to claim 1, wherein the wash tank comprises a rigid material selected from plastics and metals.

5. The wash station according to claim 1, wherein the least one aperture is round.

6. The wash station according to claim 1, wherein the at least one aperture directs a washing fluid stream at about a 20 degree angle in relation a horizontal axis.

7. The wash station according to claim 1, wherein the wash fluid is selected from water, solvent(s), soap(s) and mixtures thereof.

8. The wash station according to claim 6, wherein the wash fluid is water.

9. The wash station according to claim 15, wherein the drive mechanism comprises a motor.

10. A process for cleaning a wiper blade (in a wash station) comprising the steps of:
(1) immersing the wiper blade in a washing fluid when the wiper blade is not in use;
(2) subjecting the wiper blade to a washing fluid, wherein the fluid may optionally be agitated prior to contacting the wiper blade.

11. The process according to claim 10, wherein the wiper blade is stored immersed in the washing fluid.

12. The process according to claim 10, wherein the wash fluid is selected from water, solvent(s), soap(s) and mixtures thereof.

13. The process according to claim 10, wherein the wash fluid is water.

14. A spray bar comprising a conduit pipe for carrying a stream of a washing fluid and at least one aperture in the conduit pipe, wherein the aperture directs the washing fluid stream at an angle of about 20 degrees in relation to a horizontal axis such that the washing fluid is agitated.
